(19) United States
(12) Patent Application Publication
(10) Pub. No.: US 2024/0285075 A1
(43) Pub. Date: Aug. 29, 2024

(54) FRONT PANEL FOR A FURNITURE BODY

(71) Applicant: PRONORM EINBAUKÜCHEN GMBH, Vlotho (DE)

(72) Inventors: Roger Klinkenberg, Voerendaal (NL); Thorsten Gösling, Bad Salzuflen (DE)

(21) Appl. No.: 18/573,742

(22) PCT Filed: Jun. 22, 2022
(86) PCT No.: PCT/DE2022/000072

§ 371 Date: Dec. 22, 2023

(30) Foreign Application Priority Data
Jun. 24, 2021 (DE) 10 2021 003 238.1

(51) Int. Cl. A47B 95/02; F21S 4/28; F21V 21/40; F21V 33/00; F21W 111/08; F21W 131/301; F21Y 103/10; F21Y 115/10

(52) U.S. Cl. CPC A47B 95/02; F21S 4/28; F21V 21/40; F21V 33/0012; A47B 2095/024; A47B 2220/005; F21W 2111/08; F21W 2131/301; F21Y 2103/10; F21Y 2115/10

(57) ABSTRACT

A front panel for a furniture body is accommodated in a recess and allows an end face of movable furniture parts, which end face is provided with a handlebar, to be gripped from behind, and which front panel has a chamber for accommodating an illuminant. The single-piece front panel has a base plate which is positioned opposite the front and which has an angled portion at a first end, to which angled portion a front wall is connected so as to form the chamber which remains visible when the furniture body is viewed from the front and which has a light exit opening, which is perpendicular to the base plate, at a distance from a base of the recess.

The invention relates to a front panel for a furniture body, which front panel is accommodated in a recess and which allows a front side of movable furniture parts such as doors, drawers or the like, which front side is provided with a handle bar, to be gripped from behind, and which front panel has a chamber for accommodating an illuminant.

Since time immemorial, handles in the case of furniture are not only handles for the actuation of drawers, doors, flaps or the like, but also stylistic elements for visual enhancement of the front of a piece of furniture. The impression of the front of a piece of furniture is nowadays often improved by the use of handle bars which extend in particular over the entire width of such a movable furniture part.

In addition to handles which are connected directly to furniture parts such as doors, drawers or the like which are movable for actuation have become known with illuminated front panels which are set back from a front wall of a furniture body and which allow a front side, which is provided with a handle bar, of these movable furniture parts to be engaged behind.

A front panel of the type described above is made available by the invention for the actuation of movable furniture parts, in the case of which according to claim 1 the front panel formed in one piece has a base plate positioned opposite the front, which base plate has, at a first end, a preferably right-angled angled portion to which a front wall is connected for the formation of the chamber which remains visible in a front view of the furniture body and which has, spaced apart from a base of the recess, a light emission opening which stands perpendicularly on the base plate.

The front panel according to the invention is primarily intended for vertical assembly, in particular for actuating doors. The accommodation of the front panel in only one recess which can be incorporated in a one-off operation into the front side of an intermediate wall or a bar is expedient in terms of manufacturing technology in this case.

The formation in one piece of the front panel allows low-cost manufacture as bulk stock, for example, from a plastic, but also from a metal, for example, in high-quality from an aluminum.

The light falls through the light emission opening which stands substantially perpendicularly on the base plate onto the front side of the base plate, whereby a band of light is created which is distributed over the entire height of the furniture part, in particular also over an entire piece of furniture.

The light which falls through the light emission opening of the chamber is guided from the base plate as a result of the positioning in relation to the front of the furniture also along the base plate to the handle bar, whereby the space between the handle bar of the movable furniture part and the base plate is reliably illuminated.

Conventional connecting techniques such as screwing, gluing or the like are highly suitable for a fixing of the front panel on the furniture body. Locking and/or spacer elements for a spaced-apart fixing on the furniture body preferably project, however, on the rear side of the front panel, for example, formed in an L-shape and/or T-shape in a cross-section. A locking, for example, by pushing the furniture part, possibly one or more assembly plates, into corresponding grooves, is not only a secure, but also an invisible fastening. Formed as spacer elements, these elements define the position of the front panel, for example, in a groove in the body. Such locking or spacer elements which are L-shaped and/or T-shaped in a cross-section furthermore reinforce the front panel.

It can furthermore be provided that an end portion with a side part is connected to the base plate opposite the chamber, wherein the end portion can preferably be curved in an S-shape in order to increase stability.

If the front wall of the chamber has an elongation with a side part, the front panel thus preferably has on both sides a termination which can possibly also remain visible.

This may be advantageous if the locking elements, the spacer elements and the side parts keep the front panel spaced apart from an arcuate base of the recess.

Optimal retention can be achieved if a spring which locks in the furniture body is connected to the angled portion, thus approximately in the center of the front panel.

The guidance of light along the wall is further improved by the measure if the light emission opening, which stands perpendicularly on the wall, of the chamber is closed by a strip composed of a transparent material which has a triangular cross-section.

The strip composed of a transparent material protects the illuminants from dirt and is, for example, when used in the kitchen, nevertheless easy to clean in order to ensure an optimum emission of light. As a result of the triangular cross-section, the strip furthermore acts like a light conductor which focuses the exiting light.

In one constructive configuration, it can be provided that the strip and/or an LED band is/are held in grooves in opposite walls of the chamber and/or that lugs protrude from the opposite walls, which lugs engage in grooves of the strip and/or of the LED band.

Even if LED bands are used as illuminants which have a comparatively long service life, replacement via the front sides of the front panel according to the invention, possibly after removal of a covering cap, is nevertheless possible without any problems.

The same applies to the strip composed of transparent material, for example, after scratching or denting. A change in color is also possible without a great deal of outlay by replacing the LED band and/or the strip.

It is further provided for the actuation of oppositely attached doors that a second, mirror-inverted front panel is connected to a first front panel. As a result of this, a joint, illuminated gap is formed between the two doors for opening thereof.

In particular, this front panel is mirror-symmetrical in relation to a central plane if a joint front wall of the two chambers is formed by the connection. Only one central, joint spring is then required for the fixing.

The piece of furniture obtained in this manner with a front panel according to the invention with a handle bar composed of a solid profile having a recessed grip, which solid profile is inserted in a right-angled corner recess in a front side of the movable furniture part which furthermore engages over the front side with a lug and which engages with a lower-side locking element into the furniture part, satisfies the highest requirements.

The invention is explained in greater detail on the basis of the drawing in which only exemplary embodiments are represented. In the drawing:

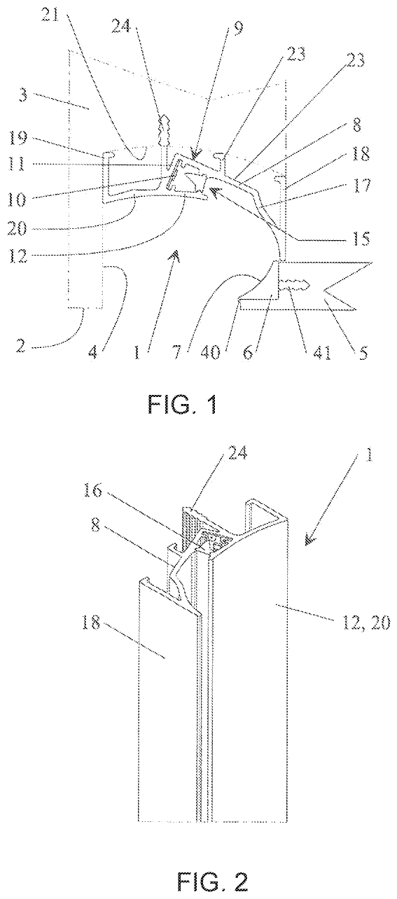

FIG. 1: shows a front-side representation of a front panel according to the invention,

FIG. 2 shows an isometric representation of the front panel,

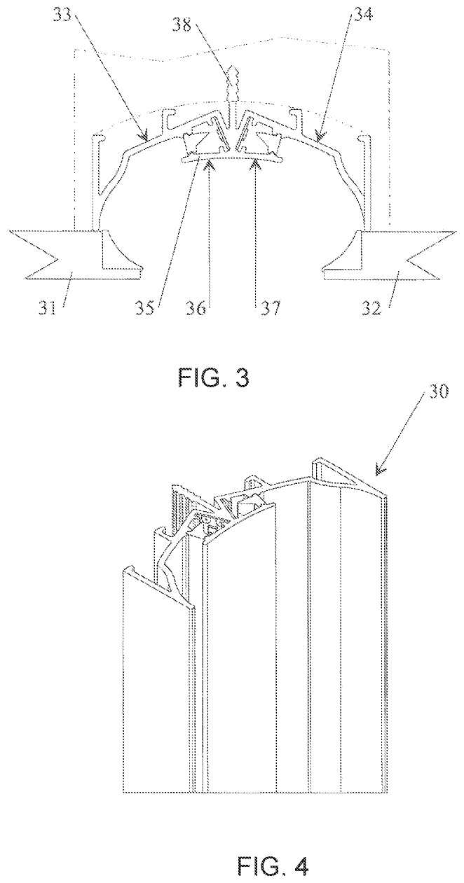

FIG. 3 shows a front-side view of a further front panel and

FIG. 4 shows an isometric representation of the front panel according to FIG. 3.

The front panel 1 represented in the drawing and formed in one piece is set back with respect to a front 2 of a furniture body 3 so far in the recess 4 that it is possible to grip behind a solid handle bar 6 with a recessed grip 7 for an actuation of a movable furniture part 5 such as a door, a drawer or like.

The front panel 1 is suitable in particular for vertical installation.

The front panel 1 has a base plate 8 which also forms a backbone and which is positioned with respect to the front 2 in such a manner that it extends from the interior of the furniture body 3 to the movable furniture part 5.

A chamber 9 which remains visible in a front view of the furniture body 3 for accommodating illuminants 10 is provided at a first end.

For this purpose, an angled portion 11 to which a front wall 12 of the chamber 9 is connected is provided substantially at a right angle at the first end of the base plate 8.

The walls of the chamber 9 are light-impermeable and leave a light emission opening 15 which stands perpendicularly on the base plate 8 and which is closed by a strip 16 of triangular cross-section composed of a transparent material.

The light of the illuminants thus falls exclusively through the transparent strip 16 onto the base plate 8 and illuminates the space between the handle bar 6 and the base plate 8 with a connected, S-shaped end portion 17. In one view, a light band thus appears over the length of the front panel 1.

In the chamber 9, the strip 16 is held with a lug in a groove in the base plate 8 or by a lug on the front wall 12 in a recess in the strip 13. The LED band which bears the illuminants 10 on the end of the chamber opposite the light emission opening 15 is also caught in grooves.

In the case of the front panel 1, a side part 18 which can also remain visible, cf. right half of FIG. 1, is connected to the end portion 17 with an S-shaped profile. A further side part 19 is provided opposite, which side part 19 is connected to an elongation 20 of the front wall 12 of the chamber 9.

In addition to the offset side parts 18,19, in this case an L-shaped, possibly Y-shaped locking or spacer element 23 protrudes for a spaced apart fixing of the front panel 1 from an arcuate base 21 of the recess 4 of the rear side 22 of the base plate 8.

The side parts 18,19 or the locking or spacer elements 23 can be pushed into corresponding grooves in the furniture body, possibly into the fastening plate that is formed separately.

Here, a spring 24 with a sawtooth-like profile, which locks in a groove in the base 21 of the recess 4 such that it cannot be pulled out, is provided for a fastening of the front panel 1 to the angled portion 11 of the chamber 9.

The front panel 30 according to FIGS. 3 and 4 is suitable in particular for installation between two oppositely attached doors 31,32. The front panel 30 is fundamentally composed of a first and second, connected in a mirror-inverted manner, front panel 33,34 of the type explained above while dispensing with an elongation of the front sides with side parts. The connection is performed in such a manner that a joint front wall 35 of the chambers 36, 37 is formed. A joint spring 38 for fixing the front panel 30 is provided between the chambers 36,37. A structure, which is mirror-symmetrical with respect to a central plane, of the front panel 30 is thus produced.

The handle bar 6 shown in FIG. 1 composed of a solid profile having the recessed grip 7 is inserted into a right-angled corner recess, which faces the furniture body 3, in a front side of the movable furniture part 5 and engages over the front side of the furniture part 6 with a lug 40. A locking element 41 projects from the bottom side of the handle bar 6, which locking element 41 engages into the furniture part 5, for example, in the form of a spring with a sawtooth-like profile which engages in a front-side groove in the furniture part 5 so that it cannot be pulled out.

1-13. (canceled)

14. A front panel for a furniture body having a front with a recess formed therein, the front panel being accommodated in the recess of the furniture body, and for allowing a front side of movable furniture parts to be gripped from behind, the front side having a handle bar, the front panel comprising:
the front panel being formed in one piece, the front panel containing:
a chamber for accommodating an illuminant; and
a base plate positioned opposite the front of the furniture body and having at a first end, an angled portion to which a front wall is connected for a formation of said chamber which remains visible in a front view of the furniture body and said chamber having, spaced apart from a base of the recess, a light emission opening formed therein which stands perpendicularly on said base plate.

15. The front panel according to claim 14, further comprising rear-side locking and/or spacer elements for a spaced-apart fixing of the front panel on the furniture body.

16. The front panel according to claim 15, further comprising an end portion with a side part connected to said base plate opposite said chamber.

17. The front panel according to claim 16, wherein said end portion is curved in an S-shape.

18. The front panel according to claim 16, wherein said front wall defining said chamber has an elongation with a side part.

19. The front panel according to claim 18, wherein said rear-side locking and/or spacer elements include locking elements and spacer elements, said spacer elements, said side part of said front wall and said side part of said end portion hold the front panel spaced apart from an arcuate base of said recess.

20. The front panel according to claim 14, further comprising a spring locking in the furniture body and is connected to said angled portion.

21. The front panel according to claim 14, further comprising a strip composed of a transparent material and having a triangular cross-section, wherein said light emission opening of said chamber is closed by said strip.

22. The front panel according to claim 21,
wherein said chamber has opposite walls with grooves formed therein;
further comprising an LED band;
wherein said strip and/or said LED band is held in said grooves in said opposite walls of said chamber;
further comprising lugs protruding from said opposite walls;
wherein said strip has grooves formed therein;
wherein said LED band has grooves formed therein; and
said lugs engage in said grooves of said strip and/or of said LED band.

23. The front panel according to claim 14, wherein the front panel contains:
a first front panel part; and
a second, mirror-inverted front panel part connected to said first front panel part.

24. The front panel according to claim 23, wherein:
said chamber is one of two chambers, each of said first front panel part and said second, mirror-inverted front panel part have one of said chambers; and
said front wall is a joint front wall of said two chambers formed by a connection.

25. The front panel according to claim 23, further comprising a joint spring.

26. The front panel according to claim 21,
wherein said chamber has opposite walls with grooves formed therein;
further comprising an LED band; and
wherein said strip and/or said LED band is held in said grooves in said opposite walls of said chamber.

27. The front panel according to claim 21,
wherein said chamber has opposite walls;
further comprising lugs protruding from said opposite walls;
wherein said strip has grooves formed therein;
further comprising an LED band having grooves formed therein; and
wherein said lugs engage in said grooves of said strip and/or of said LED band.

28. The front panel according to claim 21, wherein the movable furniture parts are doors or drawers.

29. A piece of furniture, comprising:
a handle bar composed of a solid profile having a recessed grip, a lower-side locking element and a lug;
a movable furniture part having a right-angled corner recess formed in a front side of said movable furniture part; and
the front panel according to claim 1, said solid profile is inserted in said right-angled corner recess and engages over a front side of said movable furniture part with said lug and engages into said movable furniture part with said lower-side locking element.
